(19) United States
(12) Patent Application Publication
(10) Pub. No.: US 2010/0059329 A1
(43) Pub. Date: Mar. 11, 2010

(54) METHOD AND APPARATUS FOR VENDING MERCHANDISE

(76) Inventor: Josef W. Schwarzli, Stouffville (CA)

Correspondence Address: DIMOCK STRATTON LLP, 20 QUEEN STREET WEST, 32nd FLOOR, BOX 102, TORONTO, ON, M5H 3R3, CA

(21) Appl. No.: 12/447,741

(22) PCT Filed: Aug. 21, 2008
(86) PCT No.: PCT/CA08/01486

§ 371 Date: Nov. 3, 2009

(30) Foreign Application Priority Data
Aug. 23, 2007 (CA) 2598374

(51) Int. Cl. G07F 11/66; G07F 7/04; B65D 83/00

(52) U.S. Cl. 194/206; 221/30; 221/1

(57) ABSTRACT

An apparatus for dispensing a merchandise ribbon composed of a plurality of product units joined in series comprises a ribbon advancing mechanism for engaging a product unit and forcing the ribbon along a dispensing path, a cutting mechanism positioned to cut through a web after the ribbon advancing member has advanced the ribbon to a dispensing position, and an actuating mechanism for moving the ribbon advancing member and actuating the cutting mechanism.

### FIELD OF THE INVENTION

This invention relates to vending machines. In particular, this invention relates to a method and apparatus for vending merchandise packaged in a ribbon.

### BACKGROUND OF THE INVENTION

Bulk venders, often colloquially known as “gumball machines,” are used to dispense various types of merchandise. Bulk venders conventionally comprise a merchandise bin or ‘globe’ seated over a revolving dispensing wheel which provides compartments into which the bulk product falls. As the dispensing wheel is rotated by a user through rotating a coin mechanism, a compartment is brought into alignment with the opening of a dispensing chute, and the product is thus dispensed through the dispensing chute to the user.

While bulk venders can be used to vend many types of small products, including toys and the like, by far the most popular use for bulk venders is for dispensing confectionary such as gum and other types of candy, and small snacks such as peanuts, cashews, etc. Unless the product being dispensed is soft or awkwardly shaped, in which case it may be packed into a hard-shelled capsule before being loaded into a bulk vender, the product is typically loaded into the globe of a bulk vender without any packaging and dispensed in this form.

Recently consumers have become more aware of and concerned with disease-transmitting microbes. Many consumers are now adverse to purchasing products which are perceived as being potentially unsafe, for example where the product may have been handled in an unsanitary fashion. This has resulted in a loss of sales from bulk venders. Despite attempts by operators to maintain sanitary conditions in the treatment of merchandise and loading of bulk venders, where the bulk merchandise is not packaged the perception remains that the potential for such merchandise to carry disease-transmitting microbes remains prevalent. In the absence of a clear indicator that the bulk product is sanitary, skeptical consumers will avoid purchasing the product.

Many types of products that can be sold in bulk venders are initially packaged by the manufacturer in a hermetically sealed packaging such as cellophane formed in a ribbon of attached units. Typically, the manufacturer separates the individual units of the product from the ribbon, generally by machines that use optical recognition techniques to detect separation indicators printed on the ribbon at each web between product units and slice through the ribbon at the identified locations. However, the detection mechanisms utilized by such machines are expensive and require electrical power from a mains power supply.

One of the advantages of bulk venders, which gives operators considerable flexibility in the placement of bulk venders, is they do not require power to operate. While this is a benefit in terms of the variety of places in which bulk venders can be used, it considerably reduces the types of mechanisms that can be utilized in bulk venders. Consumer acceptance requires that a bulk vender which has accepted a purchaser's coin must dispense a product, otherwise the purchaser will never use another bulk vender. As such, battery power is generally not practical if battery failure would result in a failure of the vender. On the other hand, separating individual units of packaged merchandise from a ribbon before loading the bulk vender is time consuming and costly, and impractical for many operators who service hundreds of bulk venders.

It would accordingly be advantageous to provide a vender capable of dispensing merchandise from a product ribbon and separating the individual units of merchandise as they are purchased, without the use of electrical power. This requires that the vender be able to accurately and repeatedly locate the web of ribbon between product units and cut the ribbon only at that point, so that the product is dispensed sealed in its original packaging. Given the large variety of shapes and types of merchandise that can be vended from such a vender, and the unavailability of electrically powered devices for this purpose, this presents a considerable problem.

### BRIEF DESCRIPTION OF THE DRAWINGS

In drawings which illustrate by way of example only a preferred embodiment of the invention,

FIG. 1 is a perspective view of a preferred embodiment of a dispensing mechanism according to the invention.

FIG. 1A is a perspective view of a vender utilizing the dispensing mechanism of FIG. 1.

FIG. 2 is a perspective view of a dispensing mechanism taken opposite FIG. 1, showing the rotating mechanism.

FIG. 3 is a partial plan view of a merchandise ribbon showing the web between product units.

FIG. 4 is an enlarged perspective view of a ribbon advancing member and cutter in the dispensing mechanism of FIG. 1.

FIG. 5 is a perspective view of the cutting mechanism in the dispensing mechanism of FIG. 1.

FIG. 6 is a top plan view of the cutting mechanism of FIG. 5, showing the cutting mechanism in a rest position.

FIG. 7 is a top plan view of the cutting mechanism of FIG. 5 showing the mechanism in a clamping position before cutting.

FIG. 8 is top plan view of the cutting mechanism of FIG. 5 showing the mechanism at the end of the cutting cycle.

FIG. 9 is a side elevation of the dispensing mechanism in a primed position ready to advance the merchandise ribbon.

FIG. 10 is a side elevation of the dispensing mechanism of FIG. 9 showing the ribbon advancing member after advancing the ribbon.

FIG. 11 is a side elevation of the dispensing mechanism of FIG. 9 after the clamp of the cutting mechanism has been moved to a clamping position.

FIG. 12 is a side elevation of the dispensing mechanism of FIG. 9 after the cutting cycle with the ribbon advancing member in the rest position.

FIG. 13A is a schematic side elevation illustrating the ribbon advancing mechanism with the ribbon advancing member in a rest position immediately after a product unit has been cut from the merchandise ribbon.

FIG. 13B is a schematic side elevation illustrating the ribbon advancing mechanism with the ribbon advancing member ascending toward the primed position as the dispensing cycle begins, sliding over a product unit in the merchandise ribbon.

FIG. 13C is a schematic side elevation illustrating the ribbon advancing mechanism with the ribbon advancing member in the primed position, engaging the upstream end of a product unit in the merchandise ribbon.

FIG. 13D is a schematic side elevation illustrating the ribbon advancing mechanism with the ribbon advancing member descending and advancing the merchandise ribbon toward the dispensing position.

FIG. 14A is a schematic side elevation illustrating the cutting mechanism in the open position.

FIG. 14B is a schematic side elevation illustrating the cutting mechanism in a clamping position before cutting the merchandise ribbon.

FIG. 14C is a schematic side elevation illustrating the cutting mechanism after cutting the merchandise ribbon.

FIG. 15 is a schematic side elevation of the detector for detecting an end of the merchandise ribbon in the dispensing mechanism of FIG. 1, showing the locking rod in the release position.

FIG. 16 is a schematic side elevation of the detector for detecting an end of the merchandise ribbon in FIG. 15 showing the locking rod in the locked position.

FIG. 17 is a perspective view of a dispensing mechanism according to the invention showing a further embodiment of a detector for detecting an end of the merchandise ribbon.

FIG. 18A is a partial perspective view of a dispensing mechanism according to the invention showing an electrical embodiment of a detector for detecting an end of the merchandise ribbon.

FIG. 18B is a partial side elevation of the detector for detecting an end of the merchandise ribbon in the dispensing mechanism of FIG. 18A.

### DETAILED DESCRIPTION OF THE INVENTION

The invention provides a vender for dispensing a merchandise ribbon 2, which may for example be composed of cellophane, or another type of plastic or paper (which may be plain or plastic-coated). The merchandise ribbon 2 may be manufactured by conventional methods which are well known in the art. Product units 4 are packaged into the ribbon by heat sealing along a longitudinal seam (not shown), and between each product unit 4 forming a double-layered web 6 between each product unit 4 in the ribbon 2. Many types of confectionary such as chocolate bars and the like are packaged in such a merchandise ribbon 2 as a matter of course at the time of manufacture of the confectionary. However, any type of merchandise may be packaged in a merchandise ribbon 2 for purposes of being dispensed through a vender 10 according to the present invention.

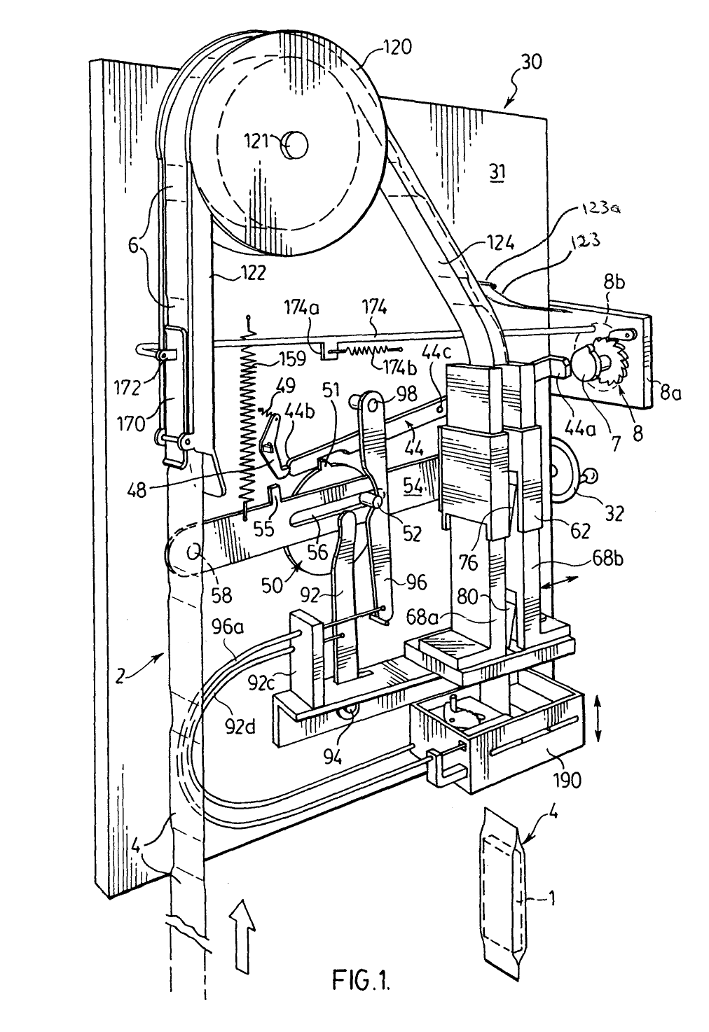

An example of a vender 10 according to the invention is illustrated in FIG. 1A. The vender 10 comprises a housing 12 which may have a transparent portion or window 14 through which the merchandise can be viewed. The vender 10 may contain any practical number of dispensing mechanisms 20 according to the invention, described in detail below. The vender 10 illustrated in FIG. 1A has four separate dispensing mechanisms 20, each having a dedicated coin mechanism 8 for releasing the dispensing mechanism to allow the dispensing cycle to proceed, and a dedicated dispensing chute 9 and crank 32. However, in other embodiments multiple dispensing mechanisms 10 may be released by a single coin mechanism 8; may dispense merchandise into a single dispensing chute; and/or may be operated by a single rotating mechanism. In other embodiments the vender 10 may contain a single dispensing mechanism 30. In each case the housing 12 is suitably designed to resist theft and vandalism, so that the vender 10 may be placed in locations which are generally unsupervised.

The vender 10 comprises a merchandise storage compartment 22 for storing a merchandise ribbon 2, preferably folded or pleated in layers and stored in a box 3 in the manner shown in phantom lines in FIG. 1A. The merchandise ribbon 2 may be packed in this fashion into a container such as a cardboard box 3 by the manufacturer, or by the operator of the vender 10, which simplifies the loading of the vender 10 and prevents tangling of the ribbon 2 as it is dispensed. The merchandise ribbon 2 may alternatively be wound around a reel or otherwise disposed in a manner which prevents tangling during payout of the merchandise ribbon 2 as product units 4 are dispensed.

The merchandise ribbon 2 is preferably hermetically sealed around the merchandise 1 sought to be dispensed, providing a clear visual impression of sanitary protection for the product 1 contained within each product unit 4. The product 1 may be a single item (for example a candy bar) as shown, or may comprise a plurality of items (for example peanuts) which are encapsulated in the product unit 4 (and may optionally also be pre-packaged). If the merchandise ribbon 2 constitutes the only packaging around the product 1, indicia such as brand names, logos and information about the product may be applied to (for example printed on) the ribbon 2 itself.

The merchandise ribbon 2 is dispensed by a dispensing mechanism 30 as illustrated in FIG. 1. The dispensing mechanism is mounted on a main frame 31, for example a steel plate as shown or any other suitable frame structure. The components of the dispensing mechanism 30 may be formed from any suitable material, preferably a metal for strength and durability.

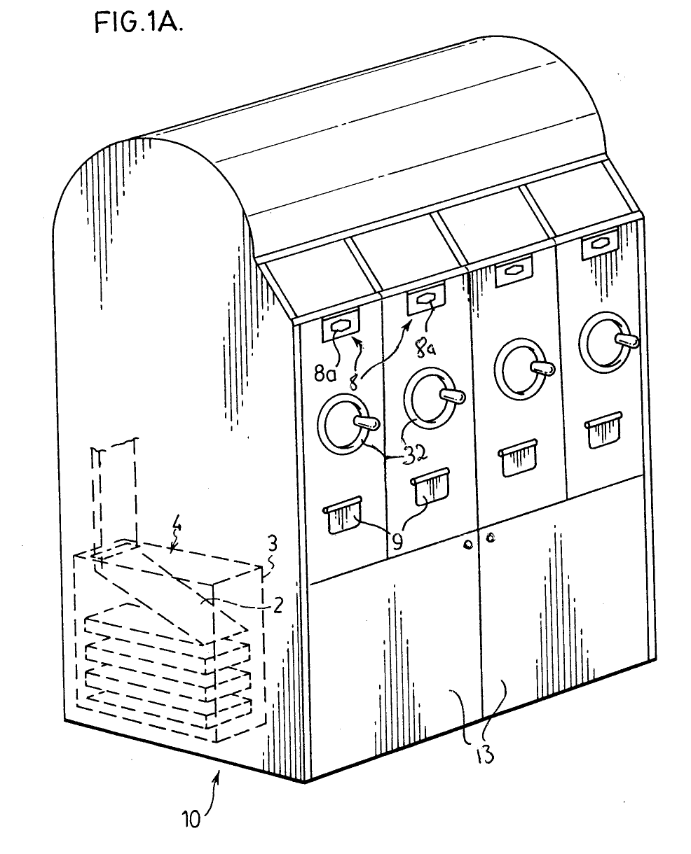

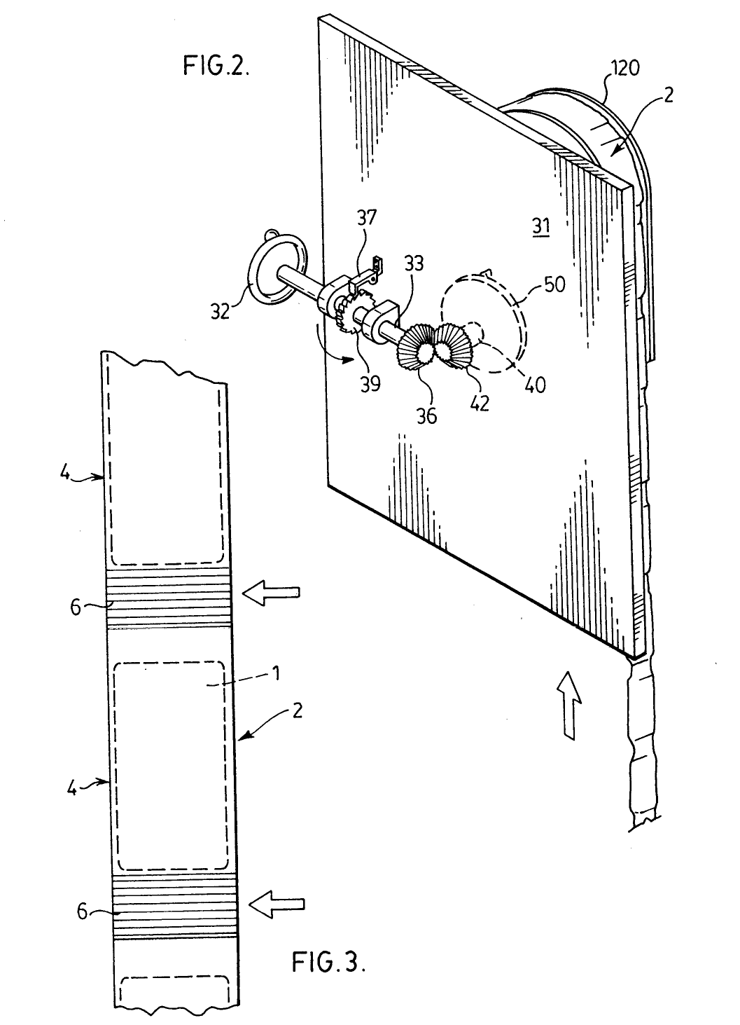

The dispensing mechanism 30 may be actuated by a crank 32, illustrated in FIG. 2, having a shaft 33 extending through supports 34 projecting from the main frame 31 of the dispensing mechanism 30. The shaft 33 terminates in a bevel gear 36 which engages a bevel gear 42 on main shaft 40 of a merchandise advancing mechanism.

The use of the crank 32 is advantageous because in the preferred embodiment the vender 10 does not require electrical power to operate. In this embodiment, the crank 30 could be replaced by a lever or other manual actuating device (not shown), and its position relative to the main frame 31 can be selected as desired using additional gears or any other suitable transmission means (not shown). However, if placed in a location where electrical power is available, the dispensing mechanism 30 could alternatively be driven by a power actuator such as an electric motor, pneumatic motor or cylinder, etc.

The main shaft 40 actuates a crank wheel 50, illustrated in FIG. 1. The crank wheel 50 actuates the ribbon advancing member 60 and the cutter 90 in the manner described in detail below. The merchandise ribbon 2 is preferably drawn over a dispensing reel 120, which may be rotatably mounted to the main frame, for example on an axle 121 as shown, disposed above the level of the advancing mechanism, which facilitates advancing the ribbon 2 because the advancing mechanism can advance the ribbon 2 downwardly, taking advantage of the force of gravity. Alternatively, the ribbon 2 may be drawn over a low-friction track or guide (not shown). It may be convenient to cast or otherwise form the dispensing reel 120 (or a track or guide) from any suitable material, such as a low-cost metal or plastic, and adhere a low-friction tape (not shown) to the surface over which the ribbon 2 slides.

Preferably a guide 122 attached to the main frame 31 upstream of the dispensing reel 120 maintains the alignment of the merchandise ribbon 2 and prevents twisting as it is drawn over the dispensing reel 120. Preferably a further guide 124 extends between the dispensing reel 120 and the ribbon advancing mechanism 60, maintaining the alignment and orientation of the merchandise ribbon 2 as it is advanced in the manner described below. The dispensing reel 120 is free-rolling, providing no resistance against the advancing mechanism so only the weight of the section of merchandise ribbon 2 from the box 3 to the dispensing reel 120 must be overcome by the ribbon advancing mechanism 60, allowing the crank to be easily turned and thus operated by a child. Optionally a resilient retaining brush 123, for example formed from spring steel and spaced a suitable distance from the guide 124, may be provided as shown in FIG. 1 to maintain the ribbon 2 within the guide 124. In the embodiment shown the free end of the brush 123 is provided with a bead 123a, to ensure that the ribbon 2 does not catch on the brush 123.

The crank wheel 50 is rotatably mounted on the main shaft 40 extending through the main frame 31, and comprises a pin 52 disposed eccentrically. The pin 52 extends through a slot 56 in a merchandise advancing arm 54 which is pivotally connected through the main frame 31 as at 58, and preferably counterbalanced for example by a spring 59 affixed between the merchandise advancing arm 54 and the main frame 31.

Disposed in the rotational path of the pin 52 are a cutter jaw actuating arm 92 pivotally connected to the frame as at 94, and cutter blade actuating arm 96 pivotally connected to the frame as at 98 and contacting a stop pin 99 in the rest position, which respectively actuate the cutting mechanism through cables 92a, 96a, the operation of which will be described below.

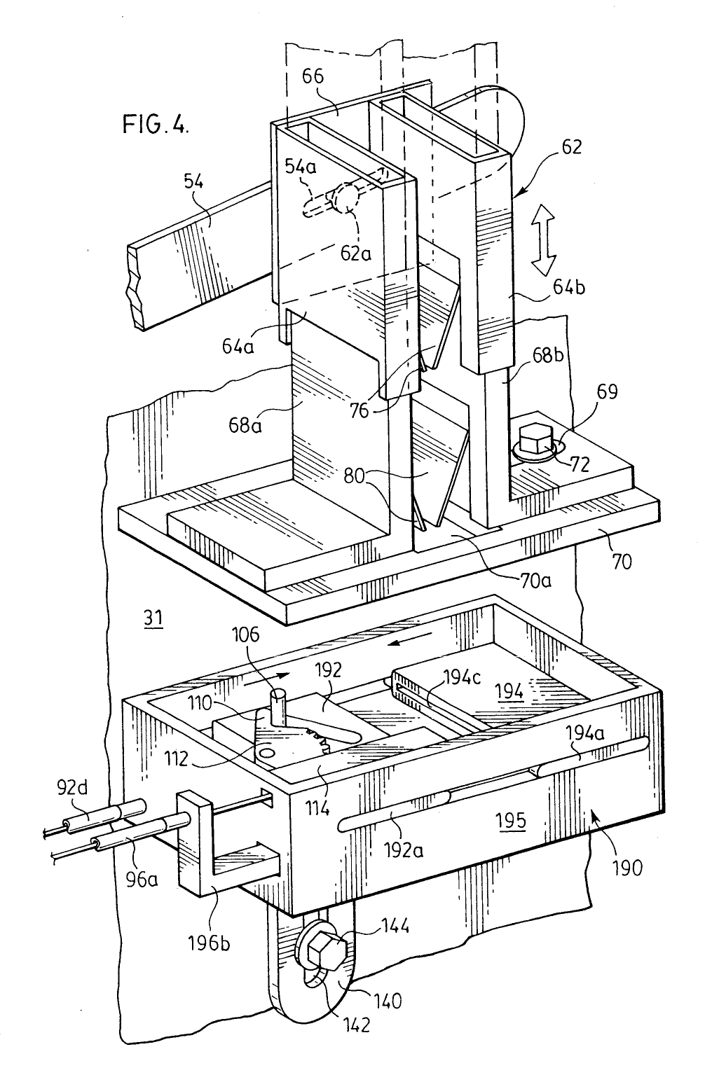

The merchandise advancing mechanism 60 comprises a ribbon advancing member 62. As best seen in FIG. 4, in the preferred embodiment the ribbon advancing member 62 comprises a pair of hollow runners 64a, 64b joined at one end, as by a plate 66 welded or otherwise affixed to the runner 64a. For adjustability the plate 66 preferably overhangs the runner 64b, and is attached to the runner 64b for example by screws (not shown) extending into the runner 64b through slots (not shown) in the plate 66, which allows the spacing between the runners 64a, 64b to be adjusted in the manner described below to accommodate merchandise ribbons 2 of different thicknesses. The runners are slidably disposed over posts 68a, 68b attached to the main frame 31. The arm 54 has a slot 54a into which a pin 62a projecting from the plate 66 merchandise advancing extends to move the ribbon advancing member 62 up and down along its path of travel.

It will be appreciated that any other suitable sliding mechanism may be used, including roller tracks (not shown) or the like. Preferably the runners 64a, 64b are durable and fit closely to the posts 68b, 68b, so that lateral motion of the runners 64a, 64b (and thus the ability to spread apart under the pressure of the advancing ribbon 2) is minimized. The posts 68b, 68b similarly are preferably rigid and may be provided with a cap (not shown) affixing the tops of the posts 68b, 68b to prevent lateral movement relative to one another, which would also allow the runners 64a, 64b to spread apart.

In a preferred embodiment a ledge 70 is welded or otherwise affixed to the main frame 31, and the posts 68a, 68b are affixed to the ledge 70 in a generally vertical orientation (although the posts 68a, 68b may be oriented obliquely if desired). Post 68b is preferably adjustably affixed to the ledge, for example by a bolt 72 extending through slot 69, which allows the position of post 68b to be moved relative to post 68a to accommodate merchandise ribbons 2 of different thicknesses, by adjusting the position of post 68b and changing the ribbon advancing member 62 to one having a suitable interior width, i.e. in which the clearance between runners 64a, 64b is slightly greater than the thickness of the particular merchandise ribbon 2 sought to be dispensed.

The merchandise advancing mechanism 60 is coupled to the ribbon advancing arm 54 as by a pin 54a fixed to the ribbon advancing arm 54 and trapped in slot 66a in the plate 66, so that the ribbon advancing member 62 slides up and down the posts 68a, 68b in a reciprocating fashion as the ribbon advancing arm 54 is pivoted by the pin 52 of the crank wheel 50.

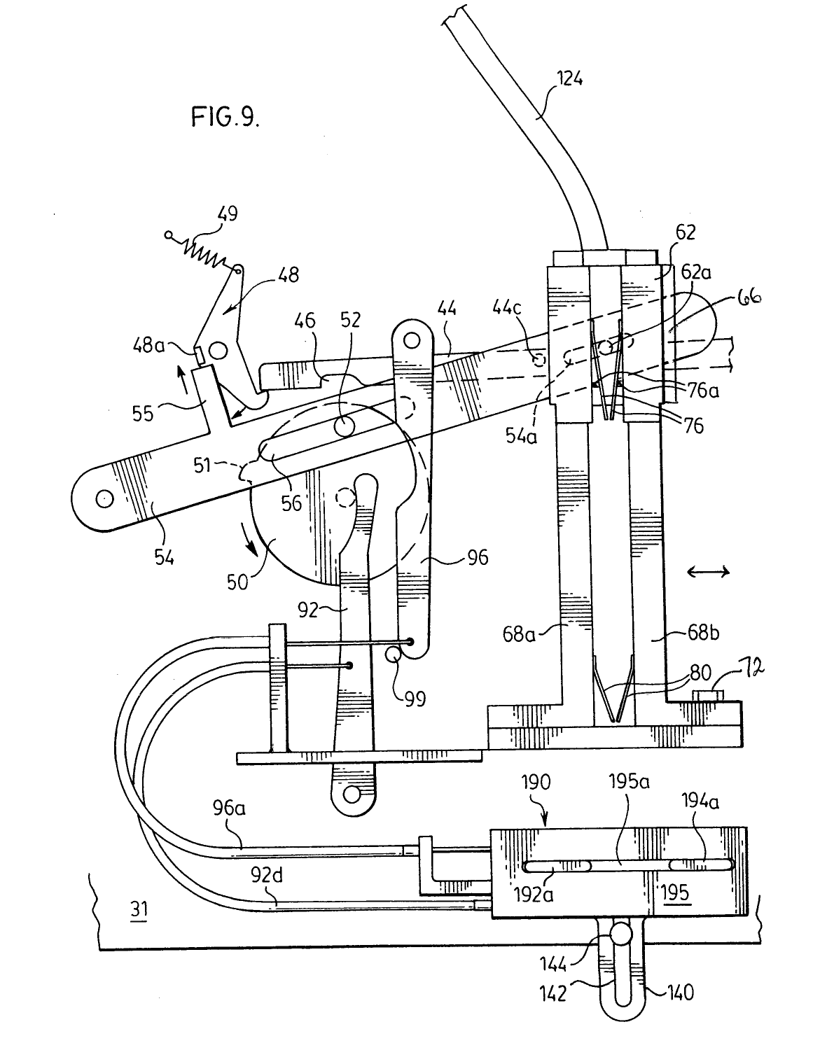

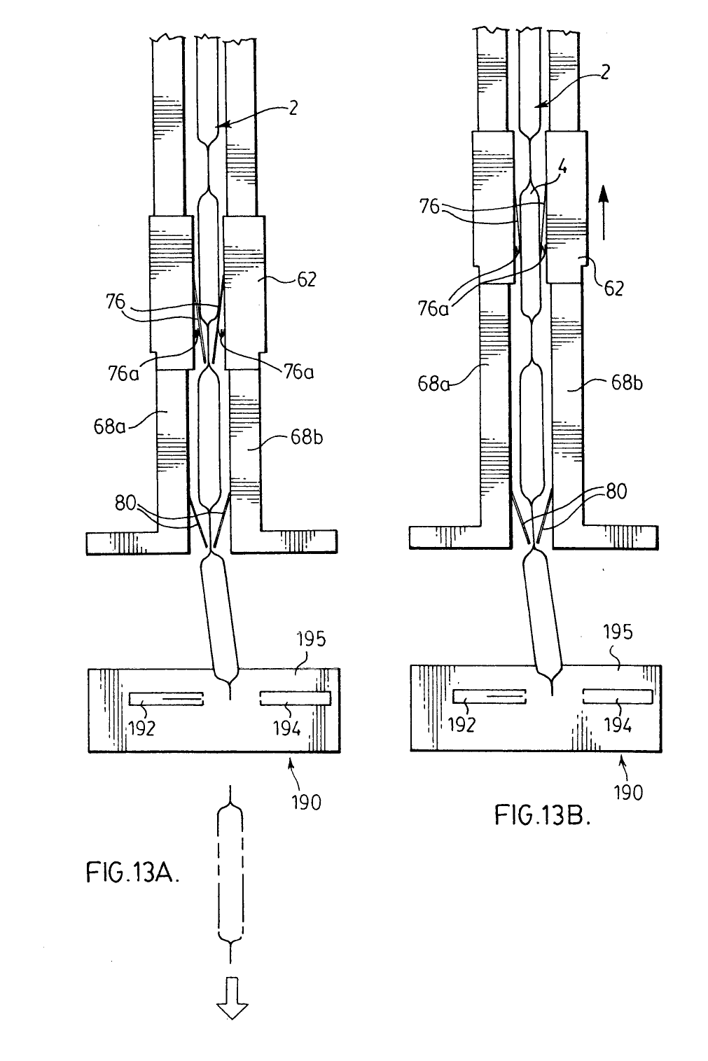

The ribbon advancing member 62 further comprises an opposed set of first grabbers 76, best seen in FIG. 9, each grabber 76 being affixed to a runner 64a and 64b and being resilient (being composed of resilient material such as spring steel, and/or being rigid and hinged to its respective runner 64a, 64b, and/or optionally biased by springs such as coil springs 76a as shown) and oriented so as to converge in a downstream direction, with the downstream edges 76a of each grabber 76 being spaced apart less than the thickness of the product 1. Thus, as runners 64a, 64b ascend toward the rest position shown in FIG. 13A the first grabbers 76 can separate to allow the relatively thicker product 1 in the product unit 4 to pass through the ribbon advancing grabbers 76 (as shown in FIG. 13B). The downstream edge 76a of each grabber 76 is preferably dull, or may be curled, provided with a bead or otherwise having a blunt configuration so as not to tear the ribbon 2 as they move along and engage an end of a product unit 4 in the manner described below.

An opposed set of second grabbers 80 is disposed near the bottom end of the posts 68a, 68b. The second grabbers 80 are similarly resilient (either being composed of resilient material such as spring steel as shown in FIG. 9, or being rigid and hinged to its respective post 68a, 68b) and oriented so as to converge in a downstream direction, with the downstream edges 80a of each grabber 80 being spaced apart less than the thickness of the product 1. This allows the grabbers 80 to separate as a product unit 4 of the merchandise ribbon 2 is pulled through the dispensing opening 70a in the ledge 70, but prevents the ribbon 2 from being drawn upstream. The downstream edge 80a of each grabber 80 is preferably dull or may be curled, provided with a bead or otherwise having a blunt configuration so as not to tear the ribbon 2 as they engage an end of a product unit 4 when the ribbon 2 moves through the ledge 70 in the manner described below.

It will be appreciated that only one of the grabbers 76 in the pair of grabbers 76 needs to be movable, and similarly only one of the grabbers 80 in the pair of grabbers 80 needs to be movable, in order to engage the end of a product unit 4. However, it is advantageous if each grabber in the pair of grabbers 76 or 80 moves, so that the grabbers 76 or 80 will engage the end of a product unit 4 generally centrally, reducing the risk of tearing the merchandise ribbon 2.

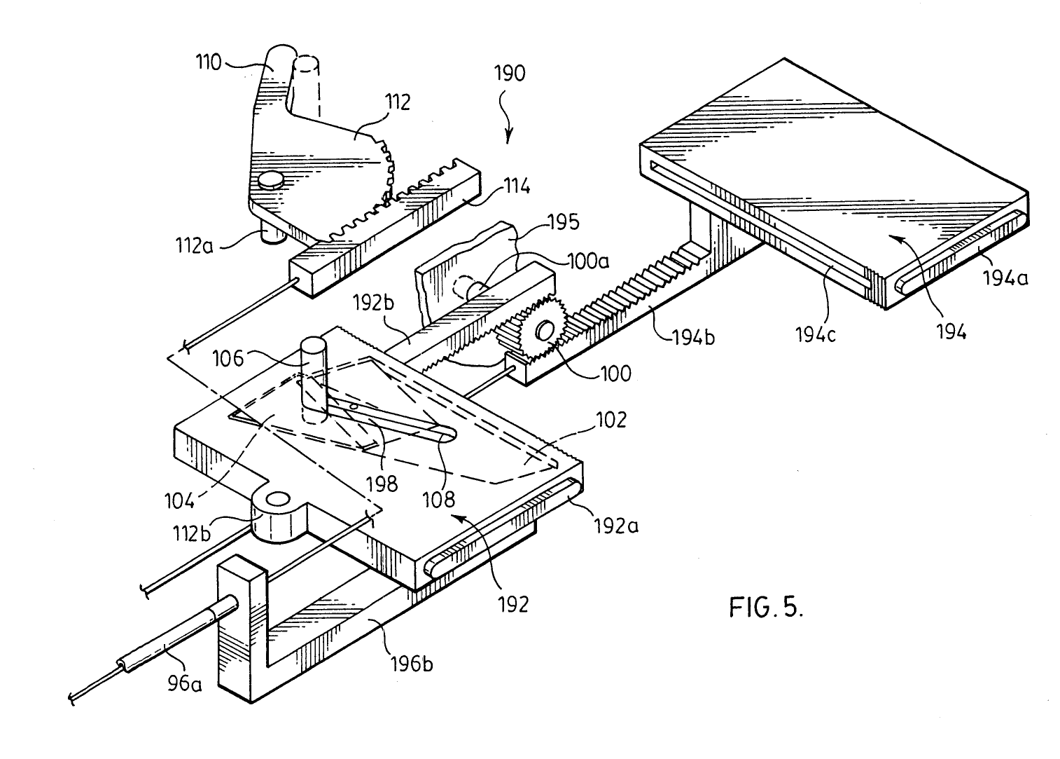

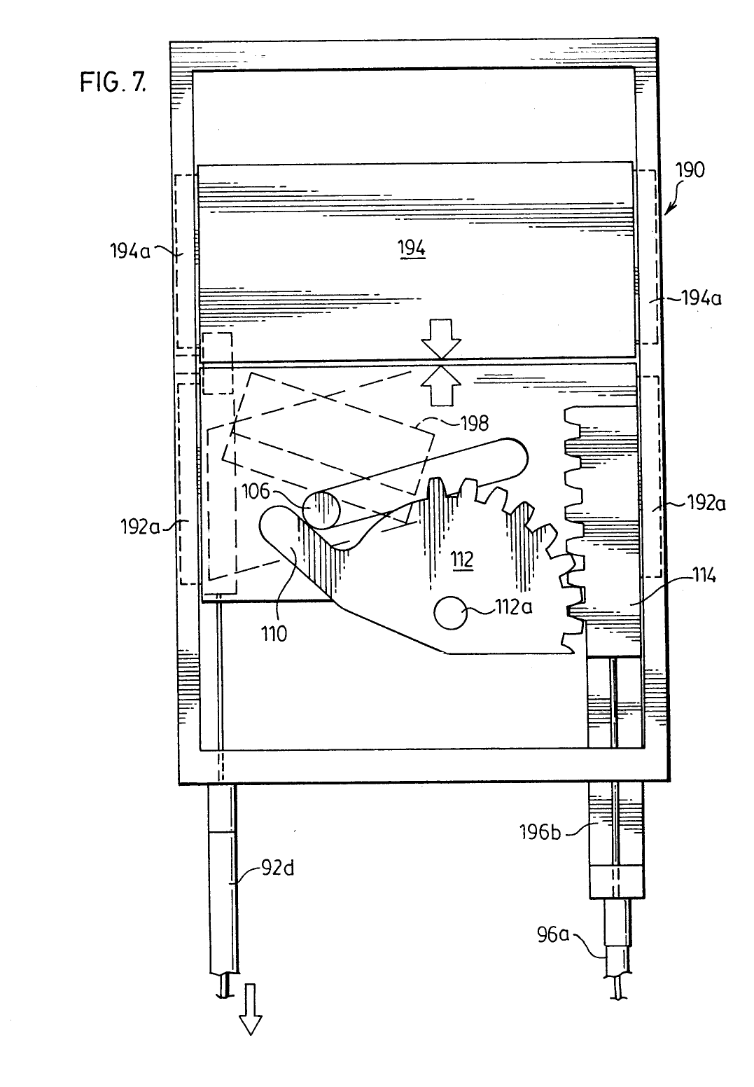

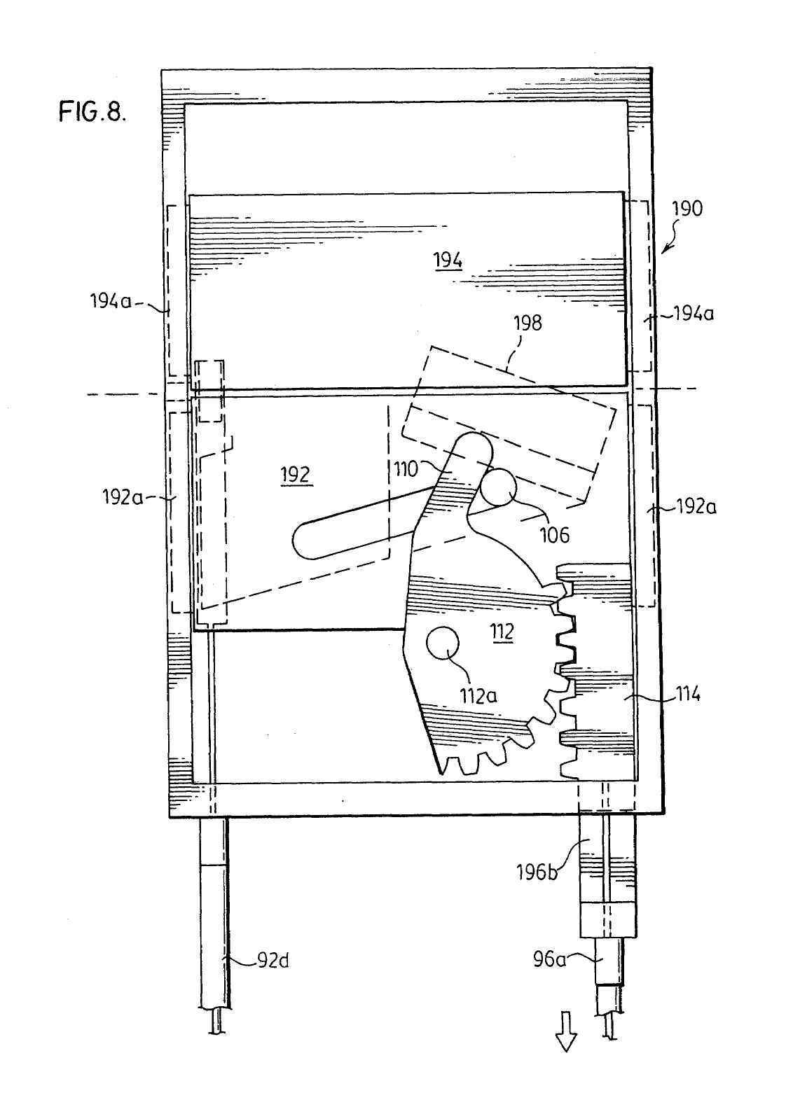

The a cutter is provided by cutting mechanism 190, shown in FIGS. 5 to 8, which comprises a pair of jaws 192, 194 slidably disposed in a cutter frame 195 (generally cutaway from FIG. 5 for purposes of illustration), for example via ribs 192a, 194a on opposite ends of the jaws 192, 194 extending through slots 195a in the side of the cutter frame 195. The jaws 192, 194 are preferably interengaged via racks 192b, 194b affixed to a common pinion 100 rotatably attached to the cutter frame 195 as by axle 100a, so that the jaws 192, 194 move in unison toward or away from one another when actuated. The cutter jaw actuating cable 92d is affixed to the cutter jaw actuating arm 92 and the jacket of cable 92d is held spaced from the cutter by the cutter frame 195.

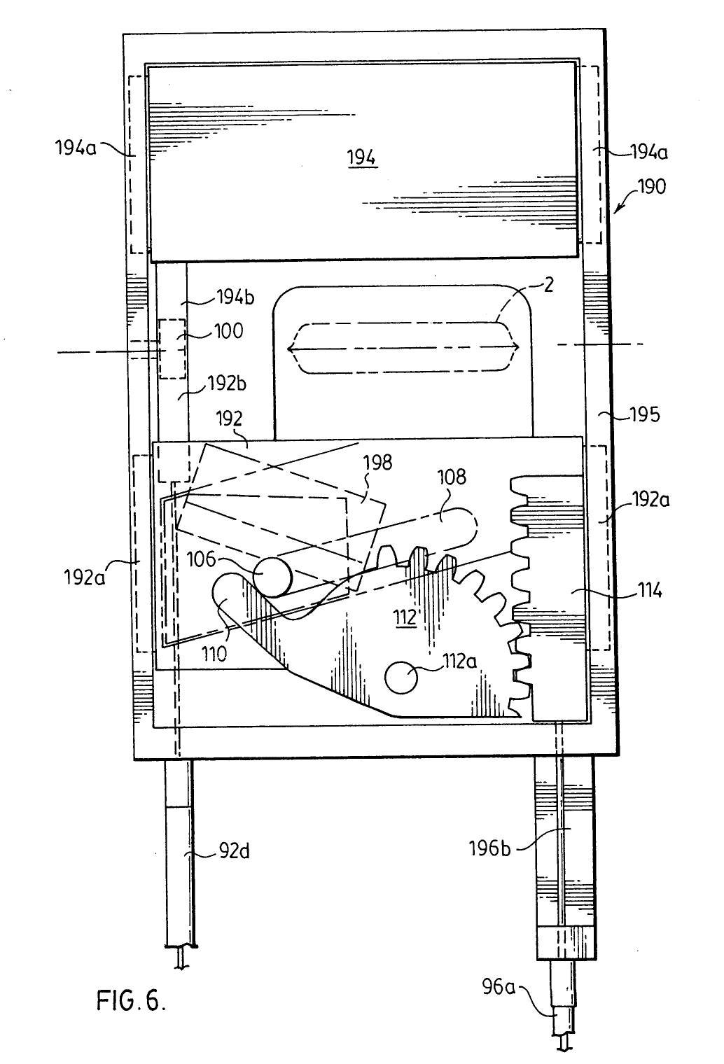

A cutting element, which may for example comprise a conventional razor blade 198, is slidably disposed within a cavity 102 in jaw 192. As best seen in FIG. 6, the razor blade 198 may for example be mounted in a slide 104 having a pin 106 extending though a slot 108 in the jaw 192. The slot 108 is oriented so that as the pin 106 is forced along the slot 108, the slide 104 moves toward the open end of the cavity 102 and thus the razor blade projects progressively further out of the jaw 192.

The pin 106 is actuated by a cam 110 projecting from a gear 112 meshing with rack 114 attached to the cutter blade actuating cable 96a. The gear 112 may for example be pivotally mounted to a pin 112a lodged in a bight 112b projecting from a rear edge of the jaw 192. The cutter blade actuating cable 96a is attached to the rack 194b, the jacket of the cable 96a being held spaced from the frame 195 by bracket 196b.

The cutter frame 195 is affixed to the main frame 31, preferably adjustably as by a tab 140 projecting from the cutter frame 195 and having a slot 142 through which bolt 144 adjustably fixes the cutter frame 195 to the main frame 31. This allows the cutting mechanism 30 to be releasably fixed closer to or further away from the dispensing opening 70a in the ledge 70, depending upon the length of the product unit 4 (measured from the longitudinal centre of one web 6 to the longitudinal centre of the next adjacent web 6) in the particular merchandise ribbon 2 being dispensed.

In the preferred embodiment the dispensing mechanism 30 is engaged by a coin mechanism 8. A suitable coin mechanism by way of example only is the rotary coin mechanism 8 as described in U.S. Pat. No. 5,383,545 to Schwarzli, which is incorporated herein by reference. However, any suitable coin acceptor can be used, and/or a bill acceptor (not shown) adapted to actuate the release bar 44 in any suitable fashion upon acceptance of the designated currency. In the embodiment shown, rotation of the coin mechanism 8 after the appropriate currency has been deposited rotates a cam wheel 7 having a cam 7a which forces a release bar 44 into the release position, as described in detail below. The main frame 31 is thus mounted within the housing of the vender 10 (for example as shown in FIG. 1A) with the associated coin mechanism 8 mounted to the housing 12 in a position that allows for the release of the dispensing mechanism 30 so that the user can drive the dispensing mechanism 30 through a dispensing cycle.

It may be convenient to mount each main frame 31 to the housing 12 on a sliding mechanism (for example drawer tracks, not shown), so that the frame 31 can be easily drawn out of the housing 12 for servicing. As shown in FIG. 1A, doors 13 may be provided for convenient access into the housing 12 for replenishment of the ribbon 2.

In operation, a box 3 containing a merchandise ribbon 2 is loaded into the storage compartment in the vender 10. The first time the vender 10 is loaded, service personnel manually draws the merchandise ribbon 2 over the dispensing reel 120 and guides 122, 124, and draws the ribbon 2 through the merchandise ribbon advancing mechanism 60 ensuring that the merchandise ribbon 2 is disposed between the sets of grabbers 76, 80, through the dispensing slot 70a in the ledge 70, and then through the cutting mechanism 190 between jaws 192, 194. The free end of the merchandise ribbon 2 thus hangs over the dispensing chute in the vender 10. If necessary, for example if the product is being changed to a thicker product, the ribbon advancing member 62 can be widened to space the runners 64a, 64b apart a distance slightly greater than the thickness of the product 1, by loosening bolt 72 and the screws (not shown) affixing the back 66 to runner 64b, positioning the post 68b in a new position to accommodate the new ribbon thickness, and then tightening bolt 72 and the screws (not shown) affixing the back 66 to runner 64b to fix the post 68b in the new position. The cutter mechanism 190 can be adjusted to accommodate merchandise of a different length by loosening the bolt 144 and positioning the cutting mechanism 190 so that the distance between the blade 198 and the downstream edges 80a of the ribbon engaging grabbers 80 is approximately the distance from the axial center of one web 6 of the merchandise ribbon 2 and the axial center of the next adjacent web 6 of the merchandise ribbon 2, and the bolt 144 is tightened to fix the cutting mechanism 190 in the new position. The bolts 72 and 144 may optionally be provided with wings, handles or some other structure which facilitates manual loosening and tightening.

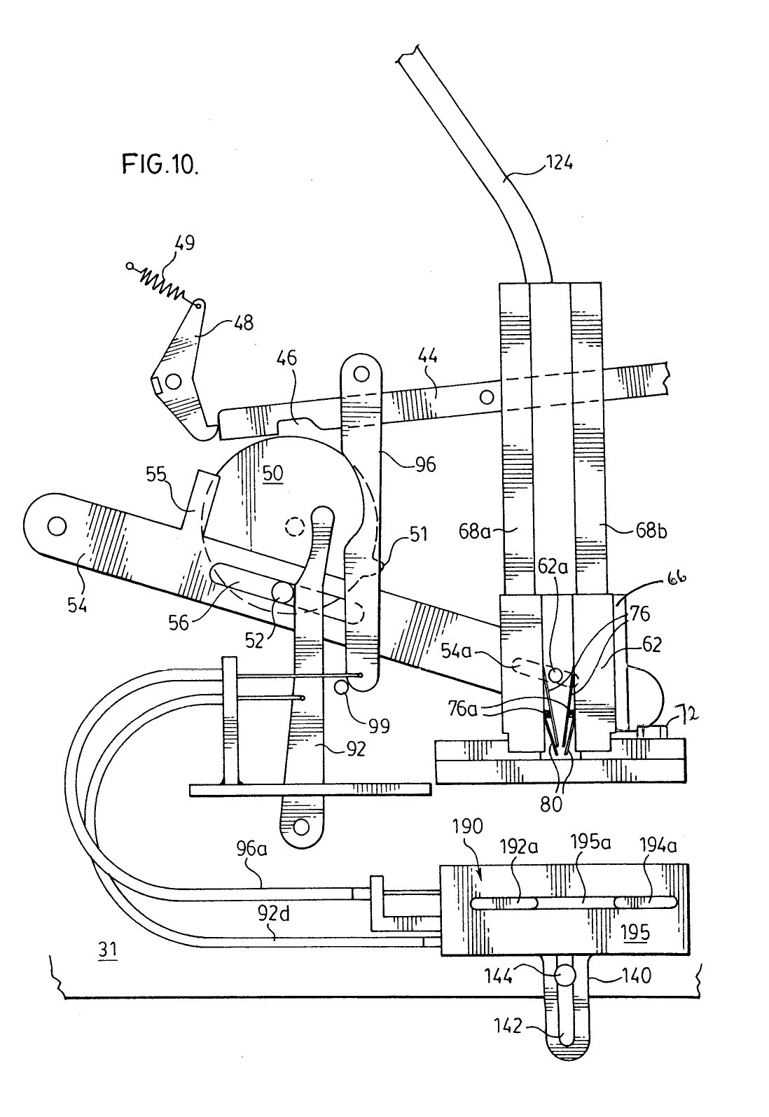

The user deposits the correct coinage into the coin mechanism 8, allowing the coin mechanism 8 to be rotated by rotation of the handle 8a, as is well known. Rotation of the coin mechanism 8 rotates a cam wheel 7, having a cam 7a which engages a release bar 44 mounted to the main frame 31 on a pivot 44c, forcing a proximate end 44a of the bar 44 down and in turn raising a distal end 44b. This releases the tooth 51 from the notch 46, allowing the crank wheel 50 to turn and thus freeing the crank 32 for rotation by the user. A pivotally mounted dog 48 biased toward the distal end 44b of the release bar 44 engages the underside of the distal end 44b to hold the release bar 44 in the release position until the tooth 51 is fully clear of the notch 46, at which point an upstanding finger 55 projecting from the rising ribbon advancing arm 54 engages a complementary finger 48a extending laterally from the dog 48, pivoting the dog 48 clear of the distal end 44b and allowing the release bar 44 to return to the rest position, as shown in FIG. 10.

The crank 32 starts in the rest position disengaged from the dispensing mechanism 30. The user can be directed by signage or other indicia to rotate the crank 32. Rotation of the crank 32 rotates the crank shaft 33 and in turn, through the engaging gear and bevel gears 36, 42, the crank wheel 50. The crank 32 is prevented from reverse rotation by a pawl 37 engaging a gear 39 mounted on the crank shaft 33, as shown in FIG. 2.

The crank wheel 50 starts in the rest position shown in FIG. 1 with the ribbon advancing member 62 at an intermediate point along the posts 68a, 68b, as shown in FIG. 13A. The pin 52 projecting from the crank wheel 50 forces the ribbon advancing arm 54 up as the pin 52 moves about its rotational cycle. The ribbon advancing arm 54 in turn forces the ribbon advancing member 62 to slide up the posts 68a, 68b, as shown in FIG. 13B, priming the ribbon advancing mechanism 60 to advance the ribbon.

Preferably in the primed (top) position the downstream edges 76a of the ribbon advancing grabbers 76 are not adjacent to a web 6, but rather are bearing against a product unit 4, so that as the ribbon advancing member 62 slides down the posts 68a, 68b the ribbon advancing grabbers 76 will slip past (or “override”) the product unit 4 to a first position where they close over the next web 6 between product units 4. This override compensates for any slippage of the ribbon 2 during a previous dispensing cycle, and compensates for any non-uniformity in the lengths of the product units 6. As such, in the embodiment shown the product 4 itself is used to compensate for any phase offset of the ribbon 2 after the previous dispensing cycle. In other words, in the preferred embodiment the ribbon advancing member 62 moves so that at the top of its path of travel on the posts 68a, 68b, the downstream edges 76a of the ribbon advancing grabbers 76 are overriding a product unit 4, as shown in FIG. 13 C. The ribbon advancing member 62 will therefore typically move a short distance down the posts 68a, 68b before it engages the next lower product unit 4 and starts to draw the ribbon 2, as shown in FIG. 13D.

Because in the rest position the downstream edges 76a of the ribbon advancing grabbers 76 are spaced apart less than the thickness of a product unit 4, as the ribbon advancing member 62 starts to move down the posts 68a, 68b, the ribbon advancing grabbers 76 will slide over the overridden product unit 4 (shown at the top of the posts 68a, 68b in FIG. 13C) and close over the web 6, bearing against the upstream end of the product unit 4 that is immediately downstream of the ribbon advancing member 62, as shown in FIG. 13D.

As the ribbon advancing member 62 descends down the posts 68a, 68b, the ribbon advancing grabbers 76 bearing against the upstream end of the product unit 4 force the product unit 4 downwardly between the posts 68a, 68b, as shown in FIG. 13D, and the merchandise ribbon 2 is thus drawn over the dispensing reel 120, pulling the ribbon 2 out of the box 3 as it moves.

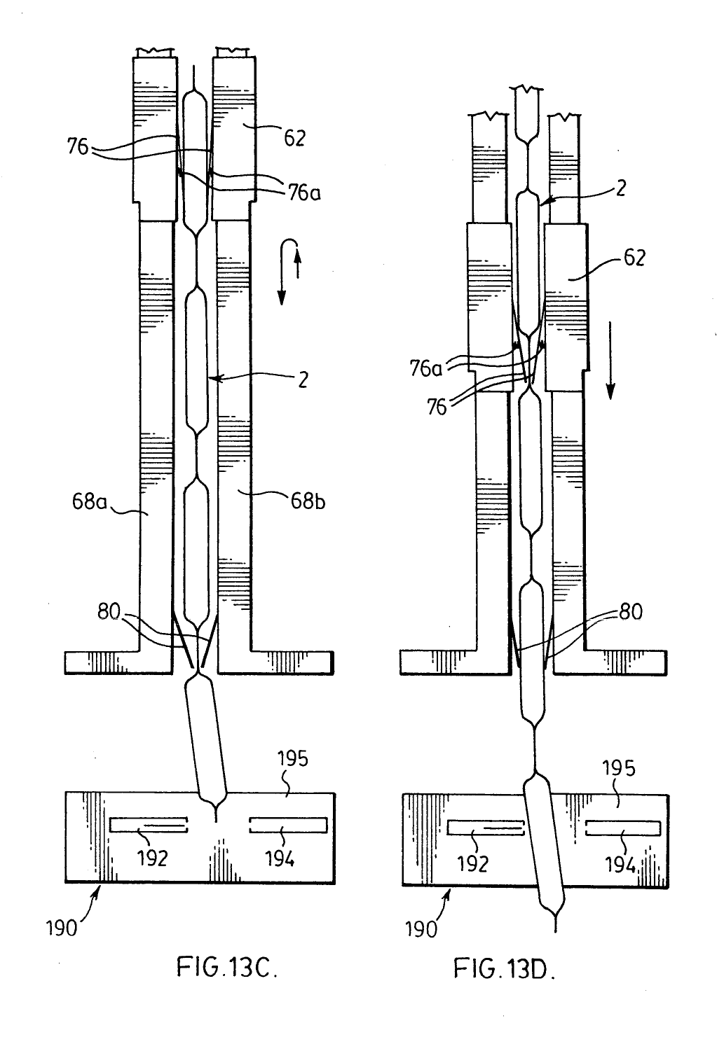

When the ribbon advancing member 62 reaches a second position, generally near the bottom of its path of travel as shown in FIGS. 10 and 14A, the downstream edges 76a of the ribbon advancing grabbers 76 nest between and are generally in the same position as the downstream edges 80a of the ribbon engaging grabbers 80. Thus, the ribbon engaging grabbers 80 are being urged against the upper end of the product unit 4 which is immediately upstream of the product unit 4 that will be dispensed.

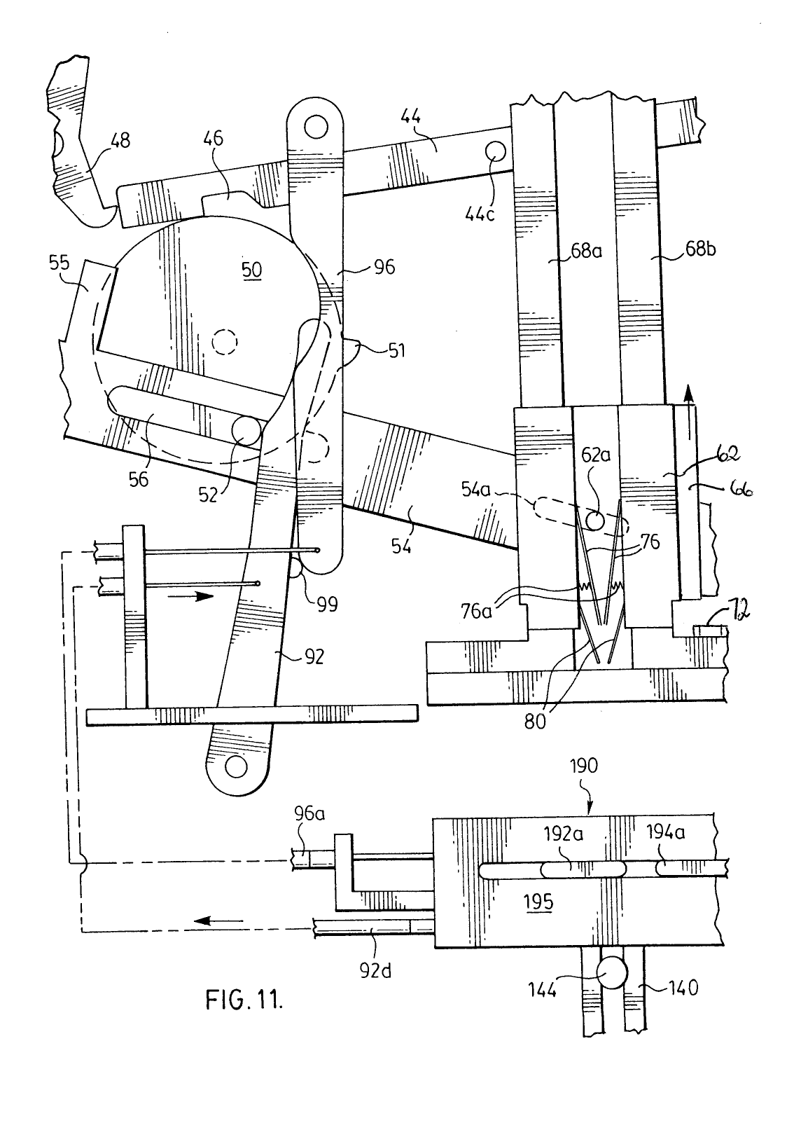

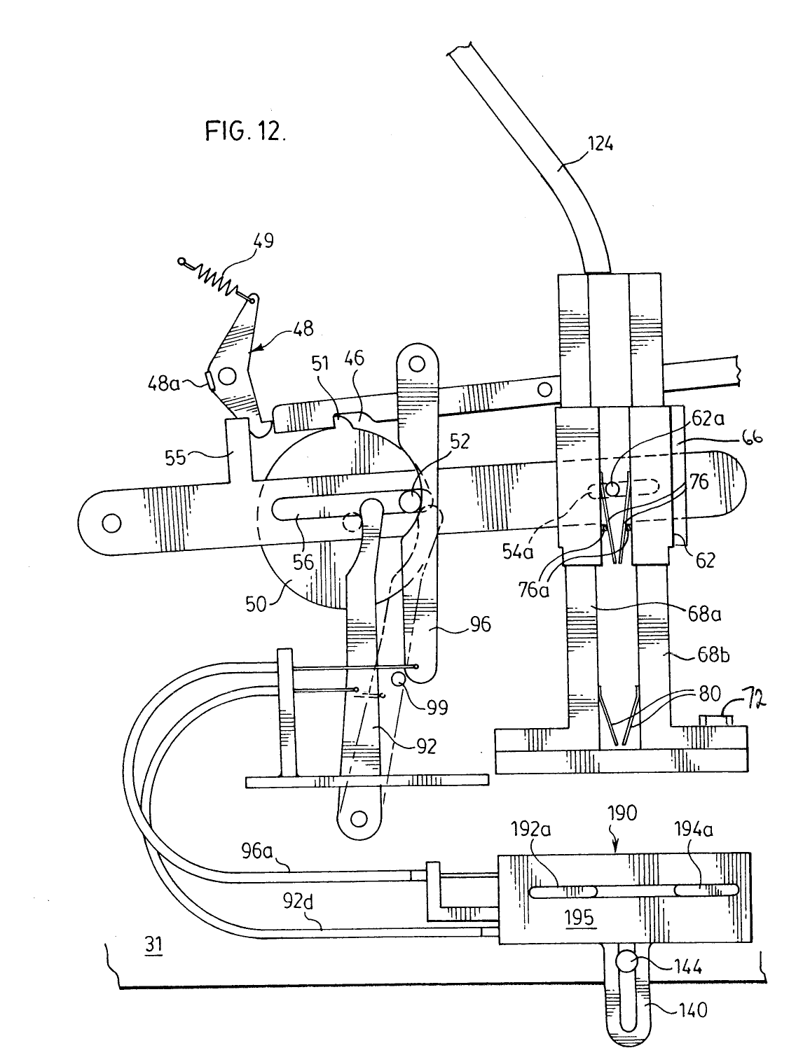

As the ribbon engaging grabbers 80 close over the web 6 and engage the upstream edge of the product unit 4 being dispensed, the pin 52 projecting from the crank wheel 50 engages the cutter jaw actuating lever 92, as shown in FIG. 10. As the crank wheel 50 continues to be rotated the cutter jaw actuating lever 92 is forced by the pin 52 to pull the cutter jaw actuating cable 92d, which in turn draws the rack 194b so that jaws 192, 194 close and clamp against the web 6 immediately upstream of the product unit 4 being dispensed, as shown in FIG. 11. This stabilizes the merchandise ribbon 2 for cutting.

As the user continues to rotate the crank 32 and thus the crank wheel 50, the pin 52 forces the cutter blade actuator lever 96 to pull the cutter blade actuator cable 96a, which draws the cutter rack 114 causing the cutter gear 112 to rotate so that the cam 100 forces the pin 106 and thus slide 104 along the cavity 102. This causes the razor blade 198 to progressively project out of the cavity 102, and into cavity 194c in jaw 194.

The razor blade 198 is preferably mounted at an angle relative to the ribbon 2 as shown, so that as the slide 104 moves across the cavity 102 the razor blade 198 progressively attacks the ribbon 2 at an angle, and a substantial amount of the length of the razor blade is used. The razor blade 198 could be oriented parallel to the ribbon 2, but more force would be required to cut the ribbon 2; or the razor blade 198 could be oriented perpendicular to the ribbon 2, but only a small part of the blade 198 would contact the web 6 during cutting and the blade would therefore have to be replaced more frequently.

When the pin 106 reaches the end of the slot 108, the razor blade 198 has fully cut through the web 6 of the ribbon 2. As a safety feature, to ensure that a user's hand is never exposed to the razor blade 198, the cutting cycle is synchronized so that as the dispensing cycle continues, the jaws 194, 194 remain closed over the web 6 and hold the severed product unit 4, and only once the razor blade 198 is fully retracted back into the jaw 192 do the jaws 192, 194 open, releasing the web 6 so that the product unit 4 being dispensed drops into the dispensing chute (not shown) and can be accessed by the user.

As the crank wheel 50 turns through the cutting cycle, the ribbon advancing arm 54 is at the same time being drawn back upwardly by the pin 52, forcing the ribbon advancing member 62 upwardly. The ribbon engaging grabbers 80 continue to bear against the immediately downstream product unit 4 and thus prevent retraction of the merchandise ribbon 2 back up into the ribbon advancing mechanism. The ribbon engaging grabbers 80 oppose the force of the ribbon advancing grabbers 76 as the ribbon advancing member 62 slides upwardly along the ribbon 2, so the ribbon advancing grabbers 76 can yield to the thickness of the product units 4 and spread apart. This allows the ascending ribbon advancing member 62 to override the product units 4 disposed between the posts 68a, 68b and return to the rest position shown in FIG. 13A, without pulling the merchandise ribbon 2 back into the dispensing mechanism 30 or causing it to bunch up between the posts 68a, 68b. Thus, at the point that the product unit 4 is severed from the ribbon 2 and dispensed to the user, the ribbon advancing member 62 and the crank wheel 50 have moved back to the rest position. This can be advantageous because once the product is dispensed the user will often stop rotating the crank 32. As the dispensing mechanism 30 reaches the end of its dispensing cycle, the tooth 51 on crank wheel 50 slips back into the notch 46 in release arm 44, preventing further rotation of the crank 32.

The next user who engages the dispensing device 30 and turns the crank 32 will move the ribbon advancing member 62 back to the primed position shown in FIG. 13C as the dispensing cycle repeats.

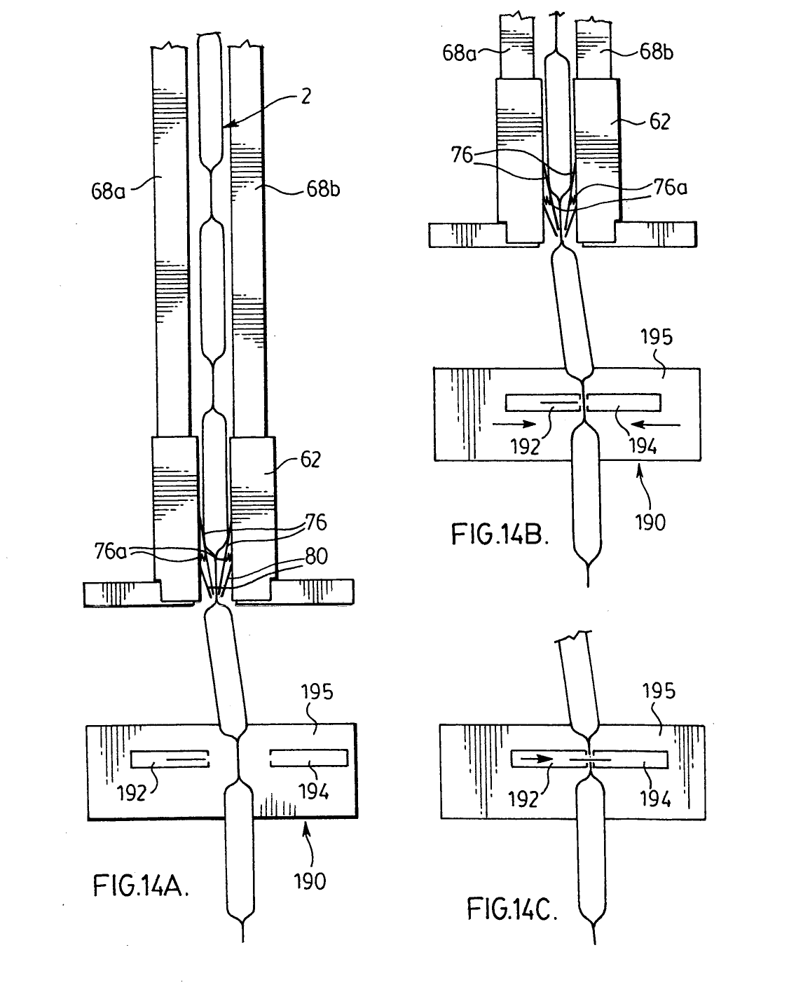

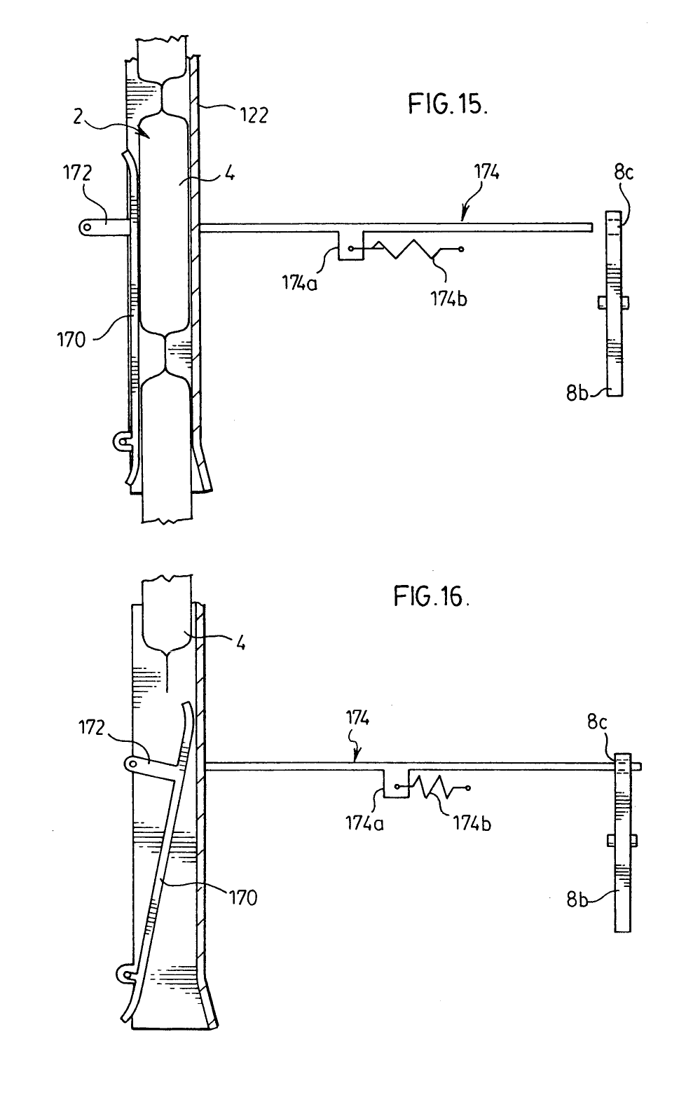

If desired, a mechanism may be provided for detecting when the end of the ribbon 2 has been reached. For example, as shown in FIGS. 1 and 15, a lever 170 may be pivotally mounted to the sidewalls of the guide 122 and biased toward the floor of the guide 122. The lever 170 is maintained in an orientation generally parallel to the floor of the guide 122, shown in solid lines, when a ribbon 2 is present. A bracket 172 extends from the lever 170 and engages the end of a locking rod 174, the other end of which is disposed through coin mechanism mounting bracket 8a immediately behind the coin conveyor 8b (as shown in FIGS. 15 and 16), but clear of the coin conveyor 8b in the unlocked position (i.e. when a ribbon 2 is present at the position of the lever 170). When the end of the ribbon 2 passes the lever 170, spring 174b lodged in the main frame 31 and tab 174a draws the rod 174 toward the coin mechanism 8 and the lever 170 collapses toward the floor of the guide 122, as shown in phantom lines. This forces the locking rod 174 into a hole 8c in the coin conveyor 8b and thus prevents rotation of the coin mechanism out of the rest position. It will be appreciated that there are many different ways in which the coin conveyor 8b may be locked by the end-of-ribbon detecting mechanism.

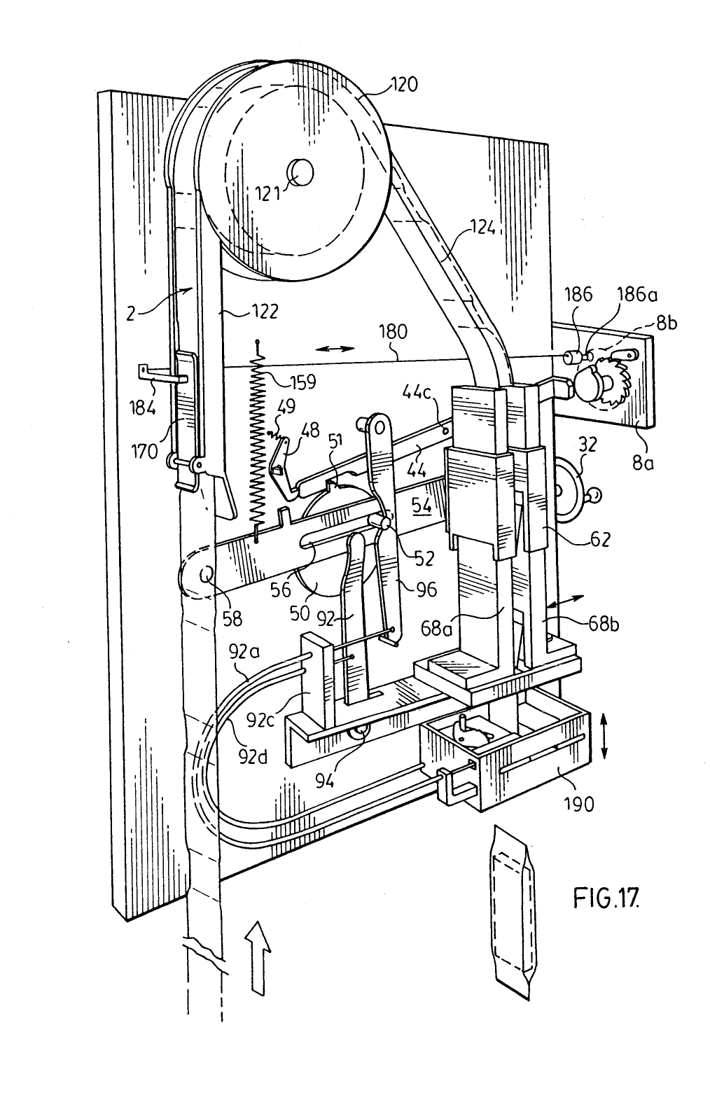

FIG. 17 shows an alternate mechanism for detecting when the end of the ribbon 2 has been reached using a cable. In this embodiment a cable 180 is affixed to the lever 170, the cable being fixed to a bracket 184 extending from the lever 170. The other end of the cable 180 is affixed to a spring-loaded latch 186 mounted beside the hole in the coin mechanism mounting bracket 8a, immediately behind the coin conveyor 8b, such that the latch pin 186a is clear of the coin conveyor 8b in the unlocked position (i.e. when a ribbon 2 is present at the position of the lever 170). When the end of the ribbon 2 passes the lever 170, the lever 170 no longer resists the bias of latch pin 186a toward the coin conveyor 8b and the lever 170 collapses toward the floor of the guide 122 as the latch pin 186a engages into the hole 8c in the coin conveyor 8b in the same manner as the rod 174 in the previously-described embodiment engages the hole 8c (as shown in FIG. 16), preventing rotation of the coin mechanism 8 out of the rest position.

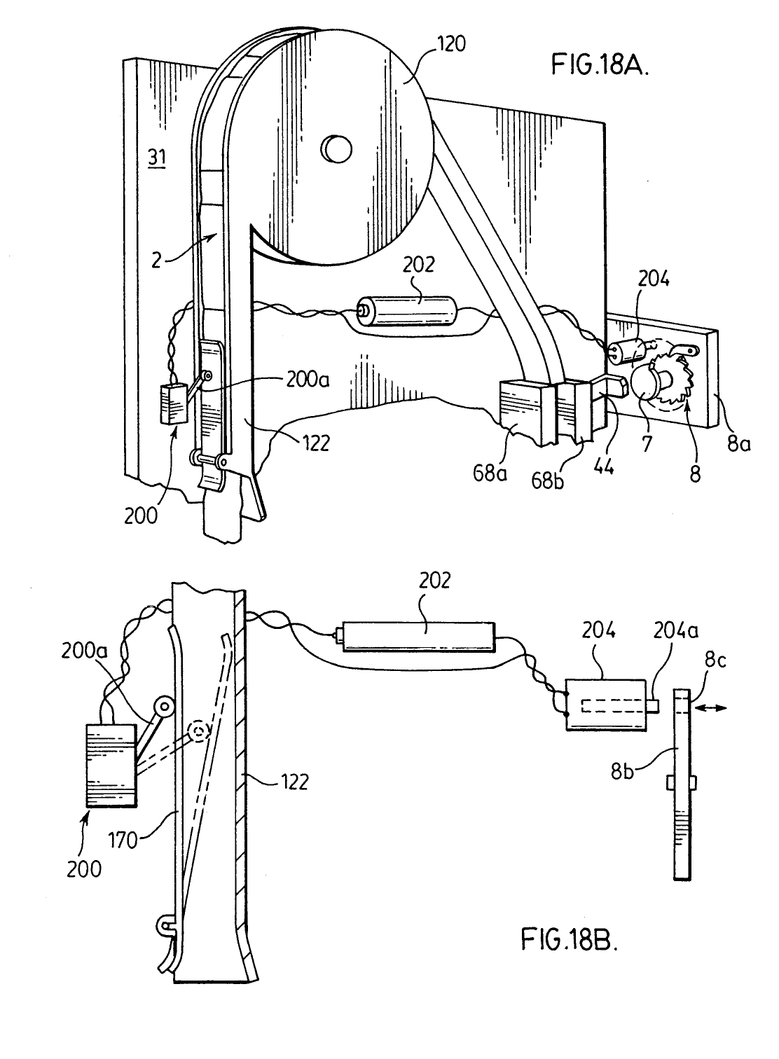

FIGS. 18A and 18B show an alternate mechanism for detecting when the end of the ribbon 2 has been reached using a solenoid. In this embodiment a ‘normally closed’ switch 200 is mounted beside the lever 170. A batter 202 has one end wired to a solenoid 204 mounted beside the hole in the coin mechanism mounting bracket 8a immediately behind the coin conveyor 8b, such that solenoid pin 204a is clear of the coin conveyor 8b when the solenoid 204 is in the retracted (quiescent) position. The switch is wired to the battery 202 and to the solenoid 204. The spring-loaded switch bar 200a remains depressed as long as the lever 170 is held away from the floor of the guide 122 by the ribbon 2, keeping the circuit open. When the end of the ribbon 2 passes the lever 170, the lever 170 collapses toward the floor of the guide 122 and the switch bar 200a closes the switch 200, in turn closing the circuit so that the solenoid pin 204a engages into the hole 8c in the coin conveyor 8b, preventing rotation of the coin mechanism 8 out of the rest position. In this embodiment, because the battery 202 has a limited life an LED or other low-current indicator may be provided to indicate that the end of the ribbon 2 has been reached, allowing service personnel to quickly respond by replenishing the ribbon 2.

To replenish the merchandise ribbon 2, service personnel will replace the empty box 3 with a new box 3 having a product ribbon 2 loaded therein, feed the leading end of the new ribbon 2 between the lever 170 and the floor of the guide 122, and tape (for example using transparent tape) or otherwise adhere the web 6 at the leading end of the new ribbon 2 with the web 6 at the trailing end of the old ribbon 2. In the process the lever 170 is returned to the rest position, drawing the locking rod 14 clear of the cam 7a and allowing the coin mechanism 8 to be rotated by the next user who inserts the required coinage.

Various embodiments of the present invention having been thus described in detail by way of example, it will be apparent to those skilled in the art that variations and modifications may be made without departing from the invention. The invention includes all such variations and modifications as fall within the scope of the appended claims.

What is claimed is:

1. An apparatus for dispensing a merchandise ribbon comprising a plurality of product units separated by a web, comprising
a merchandise advancing mechanism for engaging a product unit and forcing the ribbon along a dispensing path,
a cutting mechanism positioned to cut through a web after the ribbon advancing member has advanced the ribbon to a dispensing position, and
an actuating mechanism for moving the ribbon advancing member and actuating the cutting mechanism.

2. The apparatus of claim 1 wherein the ribbon advancing mechanism comprises
a ribbon advancing member movable between a first position and a second position, supporting at least one first grabber biased to a closed position and movable to an open position to allow one of the product units to pass the first grabber such that the first grabber engages an end of the one of the product units after the one of the product units has passed the first grabber, and
at least one second grabber disposed downstream of the first grabber, movable to an open position to allow one of the product units to pass the second grabber such that the second grabber engages an end of the one of the product units after the one of the product units has passed the second grabber to prevent retraction of the ribbon.

3. The apparatus of claim 2 wherein the ribbon advancing member supports a pair of movable grabbers.

4. The apparatus of claim 2 comprising a pair of movable second grabbers.

5. The apparatus of claim 2 wherein the ribbon advancing member comprises at least one runner slidably mounted on a post for reciprocating movement between the first and second positions.

6. The apparatus of claim 5 wherein the at least one runner is actuated by a ribbon advancing arm actuated by a user.

7. The apparatus of claim 5 wherein the ribbon advancing member comprises a pair of runners each slidably mounted on a different post.

8. The apparatus of claim 7 wherein at least one of the posts is movable, to selectively set a distance between the runners.

9. The apparatus of claim 1 wherein the cutting mechanism comprises at least one jaw slidably mounted in a frame and supporting a cutting element.

10. The apparatus of claim 9 wherein the cutting mechanism comprises a pair of opposed jaws movable in unison between closed and open positions.

11. The apparatus of claim 10 wherein the cutting element is substantially recessed into the at least one jaw and extends from the at least one jaw when the cutter is actuated to cut the ribbon.

12. The apparatus of claim 11 the cutting element extends from the at least one jaw then the pair of jaws is in the closed position.

13. The apparatus of claim 1 comprising a lever biased against the ribbon, whereby when no ribbon is present movement of the lever locks the apparatus.

14. The apparatus of claim 13 wherein the lever actuates a locking rod which engages a portion of the actuating mechanism when no ribbon is present.

15. The apparatus of claim 14 wherein the locking rod engages a rotating portion of a coin mechanism.

16. The apparatus of claim 1 wherein the merchandise advancing mechanism is unlocked by a predetermined amount of currency inserted into a currency slot.

17. The apparatus of claim 16 wherein the merchandise advancing mechanism is unlocked by a coin mechanism.

18. The apparatus of claim 16 wherein the merchandise advancing mechanism is unlocked by a bill acceptor.

19. A method of dispensing a ribbon comprising a plurality of product units separated by a web, comprising the steps of
a. engaging a first product unit,
b. moving a second product unit downstream of the first product unit to a dispensing position,
c. engaging the ribbon to prevent upstream movement thereof, and
d. cutting through a web between product units.

20. The method of claim 19 wherein the step of engaging a first product unit comprises the step of moving a ribbon advancing member to a first position; and the step of engaging the ribbon to prevent upstream movement thereof comprises the step of pushing the ribbon through at least one grabber such that the at least one grabber engages the ribbon.
